(19) United States
(12) Patent Application Publication
(10) Pub. No.: US 2020/0180711 A1
(43) Pub. Date: Jun. 11, 2020

(54) PIEZOELECTRIC BELLOW CONFIGURED TO REDUCE DRAG

(71) Applicant: GM GLOBAL TECHNOLOGY OPERATIONS LLC, Detroit, MI (US)

(72) Inventors: Taeyoung Han, Bloomfield Hills, MI (US); Chih-hung Yen, Bloomfield Hills, MI (US); Bahram Khalighi, Birmingham, MI (US)

(21) Appl. No.: 16/212,849

(22) Filed: Dec. 7, 2018

(51) Int. Cl. B62D 35/00

(52) U.S. Cl. CPC B62D 35/005; B62D 35/007; B62D 35/008

(57) ABSTRACT

An apparatus configured to reduce drag is provided. The apparatus includes a piezoelectric bellow configured to generate airflow, a power controller configured to output a signal to actuate the piezoelectric bellow, and a controller configured to control the power controller based on at least one from among pressure information and vehicle speed.

### INTRODUCTION

Apparatuses and methods consistent with exemplary embodiments relate to drag reduction. More particularly, apparatuses and methods consistent with exemplary embodiments relate to piezoelectric bellows configured to reduce drag.

### SUMMARY

One or more exemplary embodiments provide a drag reduction apparatus. More particularly, one or more exemplary embodiments provide an apparatus configured to reduce drag through the configuration of piezoelectric bellows.

According to an aspect of an exemplary embodiment, an apparatus configured to reduce drag is provided. The apparatus includes a piezoelectric bellow configured to generate airflow, a power controller configured to output a signal to actuate the piezoelectric bellow, and a controller configured to control the power controller based on at least one from among pressure information and vehicle speed.

The piezoelectric bellow may be disposed on one or more from among a top of a side view mirror of a vehicle, an A pillar of a vehicle, a bottom of an area under a front bumper of a vehicle, a bottom of an area between front and back wheels of a vehicle, wheel wells of a vehicle, a top of a trunk, a liftgate, a tailgate or a hatch of a vehicle, a bottom of an area under a rear bumper of a vehicle, and a vertical edge at a driver side or passenger side of a rear of a vehicle.

The piezoelectric bellow may include a plurality of piezoelectric bellows.

The piezoelectric bellow may include a top member, a bottom member and an inner member disposed in between the top and bottom members. The inner member may include a cavity and a nozzle, and the top and bottom members may include a piezoelectric disc and a flexible diaphragm disposed around a circumferential axis of the piezoelectric disc.

The controller may be configured to control the power controller to actuate the piezoelectric bellow if the vehicle speed is greater than predetermined actuation speed.

The power controller may be configured to adjust the power in range between 50 V and 200 V according to the speed of the vehicle and the pressure information.

The apparatus may include a vehicle speed sensor configured to measure a speed of a vehicle, and the controller may be configured to control the power controller to adjust a frequency and a voltage of power supplied to the piezoelectric bellow according to the speed of the vehicle measured by the speed sensor.

The apparatus may include a pressure sensor configured to measure a pressure of an area behind a vehicle or at a rear fender of a vehicle, and the controller is configured to control the power controller to adjust the frequency and the voltage of power supplied to the piezoelectric bellow according to the speed of the vehicle and the pressure measured by the pressure sensor.

The power controller may be configured to adjust the frequency in range between 100 Hz and 800 Hz according to the speed of the vehicle and the base pressure.

The apparatus may include a pressure sensor configured to measure a pressure of an area behind a vehicle or at a rear fender of a vehicle, and the controller may be configured to control the power controller to adjust the frequency and the voltage of power supplied to the piezoelectric bellow according to the speed of the vehicle and the pressure measured by the pressure sensor.

The piezoelectric bellow may be disposed on one or more from among a top of a side view mirror of a vehicle, an A pillar of a vehicle and a bottom of an area under a front bumper of a vehicle.

The piezoelectric bellow may be disposed on one or more from among a top of a trunk, a liftgate, a tailgate or a hatch of a vehicle, a bottom of an area under a rear bumper of a vehicle, and a vertical edge at a driver side or passenger side of a rear of a vehicle.

The piezoelectric bellow may be disposed on one or more from among a bottom of an area between front and back wheels of a vehicle and wheel wells of a vehicle.

The piezoelectric bellow may include a top member, a bottom member and an inner member disposed in between the top and bottom members, the inner member may include a cavity and a nozzle, and the top member may include a piezoelectric disc and a flexible diaphragm disposed around a circumferential axis of the piezoelectric disc.

The apparatus may include a pressure sensor configured to measure a pressure of an area around the vehicle and provide the measured pressure to the controller.

The apparatus may include a vehicle speed sensor configured to measure a speed of a vehicle and provide the measured speed to the controller.

According to an aspect of another exemplary embodiment, an apparatus configured to reduce drag is provided. The apparatus includes a vehicle speed sensor configured to provide information on vehicle speed, a pressure sensor configured to provide pressure information on an exterior area of a vehicle, a plurality of piezoelectric bellows disposed on an exterior of a vehicle and configured to generate airflow, and a controller configured to actuate the plurality of piezoelectric bellows based on at least one from among the pressure information and the vehicle speed.

The piezoelectric bellows may be disposed on one or more from among a top of a side view mirror of a vehicle, A pillar of a vehicle, a bottom of an area under a front bumper of a vehicle, a bottom of an area between front and back wheels of a vehicle, wheel wells of a vehicle, a top of a trunk, a liftgate, a tailgate or a hatch of a vehicle, a bottom of an area under a rear bumper of a vehicle, and a vertical edge at a driver side or passenger side of a rear of a vehicle.

The controller may be configured to control to actuate the piezoelectric bellows according to the speed of the vehicle measured by the speed sensor.

The controller may be configured to control to actuate the piezoelectric bellows according to the speed of the vehicle and the pressure measured by the pressure sensor.

Other objects, advantages and novel features of the exemplary embodiments will become more apparent from the following detailed description of exemplary embodiments and the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 shows a block diagram of an apparatus configured to reduce drag according to an exemplary embodiment;

FIG. 2 shows illustrations of various configurations of piezoelectric bellows controlled by an apparatus configured to reduce drag according several aspects of exemplary embodiments;

FIG. 3 shows a piezoelectric bellow of the apparatus configured to reduce drag or the apparatus according to aspects of an exemplary embodiment; and

FIG. 4 shows a flow diagram of the apparatus configured to reduce drag according to an aspect of an exemplary embodiment.

### DETAILED DESCRIPTION

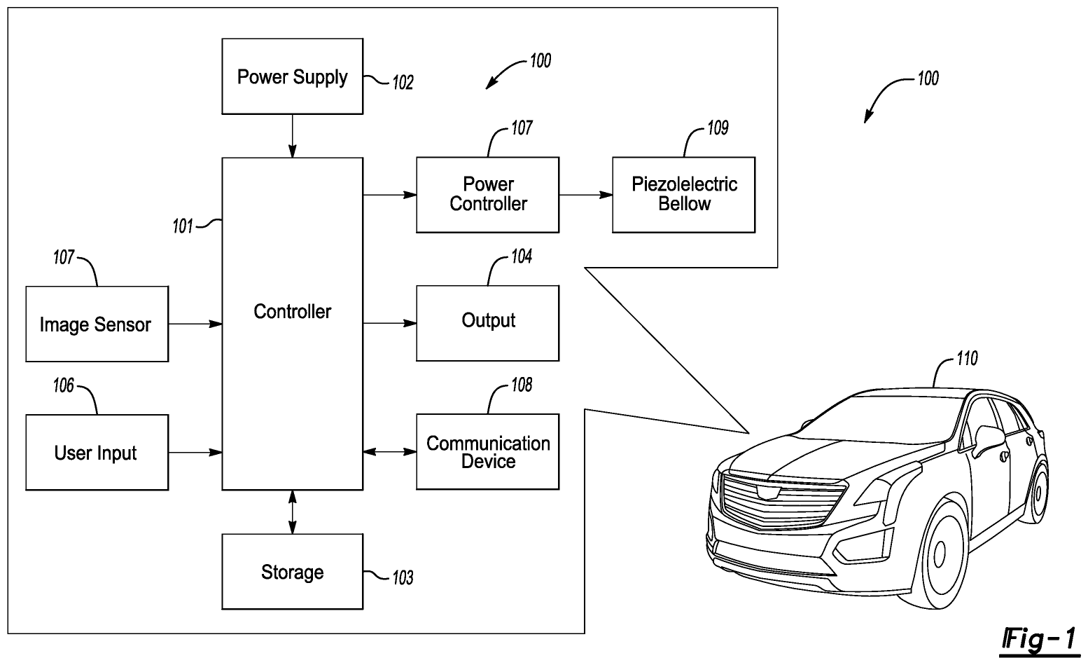

An apparatus configured to reduce drag will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Fuel economy is one of the major issues in automobile design and engineering because of regulations and consumer demand for a more fuel-efficient vehicle. Fuel efficiency depends on elements such as engine design, body design, fuel, etc. Trade-offs between fuel economy, style, size, and utility are weighted and a particular design may be selected. The shape or design of the vehicle may affect the aerodynamic drag (“drag”) of the vehicle which in turn affects fuel efficiency.

Drag can be reduced by delaying or eliminating the airflow separations on a vehicle surface or controlling the flow separation at the rear of a vehicle. Airflow controls may be implemented by adding additional mechanical devices or electromechanical devices to the body of the vehicle to regulate or deflect airflow. One type of device that may be used to affect the airflow around a vehicle is a piezoelectric bellow. However, the piezoelectric bellow needs to be controlled according to pressure around a vehicle and vehicle speed in order to more effectively reduce drag and increase stability.

FIG. 1 shows a block diagram of an apparatus configured to reduce drag 100 according to an exemplary embodiment. As shown in FIG. 1, the apparatus configured to reduce drag 100, according to an exemplary embodiment, includes a controller 101, a power supply 102, a storage 103, an output 104, a sensor 105, a user input 106, a power controller 107, a communication device 108 and a piezoelectric bellow 109. However, the apparatus configured to reduce drag 100 is not limited to the aforementioned configuration and may be configured to include additional elements and/or omit one or more of the aforementioned elements. The apparatus configured to reduce drag 100 may be implemented as part of a vehicle, as a standalone component, as a hybrid between an on vehicle and off vehicle device, or in another computing device.

The controller 101 controls the overall operation and function of the apparatus configured to reduce drag 100. The controller 101 may directly or indirectly control one or more of a power supply 102, a storage 103, an output 104, a sensor 105, a user input 106, a power controller 107, a communication device 108 and a piezoelectric bellow 109, of the apparatus configured to reduce drag 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the power supply 102, the storage 103, the output 104, the sensor 105, the user input 106, the power controller 107, the communication device 108 and the piezoelectric bellow 109 of the apparatus configured to reduce drag 100. The information may be sent and received via a bus or network, or may be directly read or written to/from one or more of the power supply 102, the storage 103, the output 104, the sensor 105, the user input 106, the power controller 107, the communication device 108 and the piezoelectric bellow 109 of the apparatus configured to reduce drag 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the storage 103, the output 104, the sensor 105, the user input 106, the power controller 107, the communication device 108 and the piezoelectric bellow 109, of the apparatus configured to reduce drag 100. The power supply 102 may include one or more from among a battery, an outlet, a capacitor, a solar energy cell, a generator, a wind energy device, an alternator, etc.

The storage 103 is configured for storing information and retrieving information used by the apparatus configured to reduce drag 100. The storage 103 may be controlled by the controller 101 to store and retrieve information received from one or more sensors 105 as well as computer or machine executable instructions to control the piezoelectric bellow 109. The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The information may include information on air pressure provided by an air pressure sensor at one or more locations around a vehicle. The information may also include information vehicle speed provided by a vehicle speed sensor.

The output 104 outputs information in one or more forms including: visual, audible and/or haptic form. The output 104 may be controlled by the controller 101 to provide outputs to the user of the apparatus configured to reduce drag 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of the activation or deactivation of the piezoelectric bellow 109 or the apparatus configured to reduce drag 100. The output 104 may also display images and information provided by one or more sensors 105.

The sensor 105 may include one or more from among a base pressure sensor, a rear driver side fender pressure sensor, a rear passenger side fender pressure sensor, a vehicle speed sensor, and any other sensor suitable for detecting aerodynamic drag around the apparatus configured to reduce drag 100. The sensor 105 may also include a vehicle speed sensor such as a speedometer, GPS device, etc.

The user input 106 is configured to provide information and commands to the apparatus configured to reduce drag 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to activate or deactivate the apparatus configured to reduce drag 100.

The power controller 107 may include circuitry including a signal generator such as a pulse generator (e.g., a solid-state pulse generator) and an amplifier. In addition, the power controller may include a direct current to direct current convertor and pulse generator such as a solid-state pulse generator. According to one example, the power controller may include transformer configured to convert AC power supplied by the power supply to an AC voltage and frequency to operate the piezoelectric bellow. According to another example, the power controller may include a direct current (DC) to DC converter configured to covert the power supplied by the power supply to an appropriate voltage and frequency to operate the piezoelectric bellow. According to yet another example, the power controller may be configured to convert 12V direct court power supplied by the power supply 102 to a power signal in the range of 50-100 V and 100-800 HZ.

The power controller may be configured to adjust the frequency of an output signal in a range between 100-800 HZ according to one or more from among the speed of the vehicle, the base pressure and the difference between rear fender pressures. The power controller may also be configured to adjust the power of an output signal in a range between 50-100 V according to according to one or more from among the speed of the vehicle, the base pressure and the difference between rear fender pressures. The voltage may be set so that the ratio peak velocity of airflow emitted by piezoelectric bellow over vehicle speed is the range of 2 to 3.

The communication device 108 may be used by apparatus configured to reduce drag 100 to communicate with several types of external apparatuses according to various communication methods. The communication device 108 may be used to send/receive various information such as information on operation mode of the vehicle and control information for operating the apparatus configured to reduce drag 100 to/from the controller 101.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

The piezoelectric bellow 109 is an electrical device that generates airflow inhaling and injecting air through the use of piezoelectric materials or parts. In particular, piezoelectric bellow 109 works by applying an electrical signal to the piezoelectric parts, thereby causing suction of air followed by emission of air. The piezoelectric bellow 109 may generate airflow with a peak velocity of around 200 m/s and an average velocity of between 60-80 m/s.

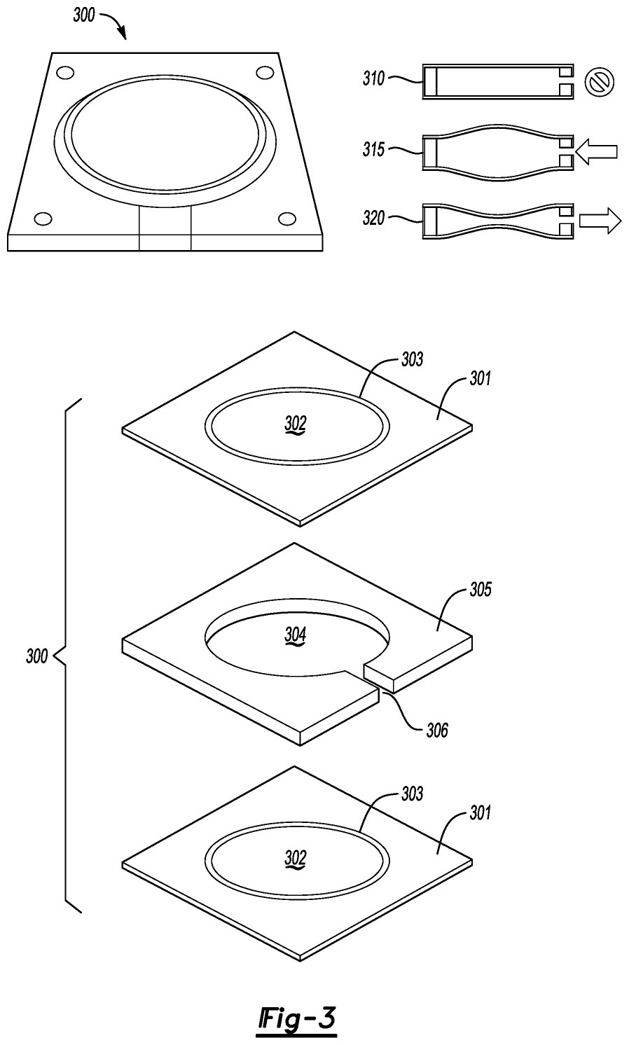

An exemplary embodiment of a piezoelectric bellow 109 of the apparatus configured to reduce drag 100 is described in detail with respect to FIG. 3. While a dual piezoelectric disc configuration is shown in FIG. 3, a single piezoelectric disc configuration may be used. Moreover, the size of the cavity can be varied to achieve maximum/optimal air velocity.

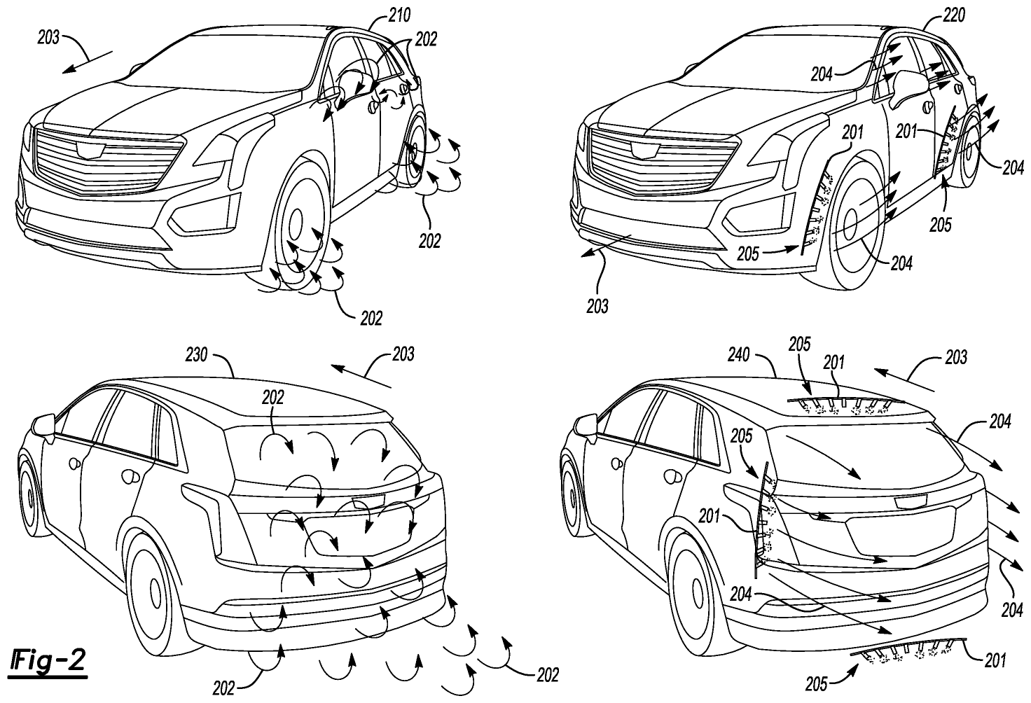

FIG. 2 shows illustrations of various configurations of piezoelectric bellows controlled by an apparatus configured to reduce drag according several aspects of exemplary embodiments. Referring to FIG. 2, two example configurations of piezoelectric bellows 201 are shown. However, the exemplary embodiments are not limited to these examples and the apparatus configured to reduce drag 100 may be have one or more piezoelectric bellows 201 at positioned to emit air jets 205 at any position on a vehicle in configuration to reduce aerodynamic drag of the vehicle or increase stability of a vehicle.

In a first example, drag 202 is generated as vehicle 210 moves in a forward direction represented by arrow 203. The drag is generated around the wheel wells and side view mirrors of vehicle 210. In vehicle 220, the piezoelectric bellows 201 of the apparatus configured to reduce drag 100 are placed in the front part of the wheel well, on the A-pillar, and side view mirror. Arrows 204 show the reduction of drag as the piezoelectric bellows 201 emit jet flows 205.

In a second example, drag 202 is generated as vehicle 230 moves in a forward direction represented by arrow 203. The drag is generated around the rear perimeter of vehicle 230. In vehicle 240, the piezoelectric bellows 201 of the apparatus configured to reduce drag 100 are placed on top of liftgate, under the rear bumper, on the rear passenger side edge, and on the rear driver side edge of vehicle 240. Arrows 204 show the reduction of drag as the piezoelectric bellows 201 emit jet flows 205.

FIG. 3 shows an example of a piezoelectric bellow 300 of the apparatus configured to reduce drag 100 according to aspects of an exemplary embodiment. Referring to FIG. 3, a piezoelectric bellow 300 and its modes of operation are shown.

The piezoelectric bellow 300 may include a top member 301 (e.g., a first piezoelectric member), a bottom member 301 (e.g., a second piezoelectric member) and an inner member 305 (e.g., a spacer) disposed in between the top and bottom members.

The inner member may include a cavity 304 and a nozzle 306. The top and bottom members may each include piezoelectric discs 302 and flexible diaphragms 303 disposed around a circumferential axis of the piezoelectric discs 302. The piezoelectric discs 302 may be encircled by top and bottom members 301 and the top and bottom members 301 may be rigid parts around the piezoelectric discs 302 or flexible diaphragms 303. The nozzle 306 may be configured to suck or draw air into the cavity and then eject the air from the cavity as the first and second piezo electric discs 302 are actuated.

Illustrations 310, 315, 320 show cutaway views of piezoelectric bellow 300 during modes of actuation. Specifically, illustration 310 shows an unactuated state of the piezoelectric bellow 300. Illustration 315 shows a first actuated state in where air is drawn or sucked through the nozzle 306 into the cavity 304. Finally, illustration 320 shows a second actuated state where air is ejected from the cavity 304 and blown or emitted by the nozzle 306.

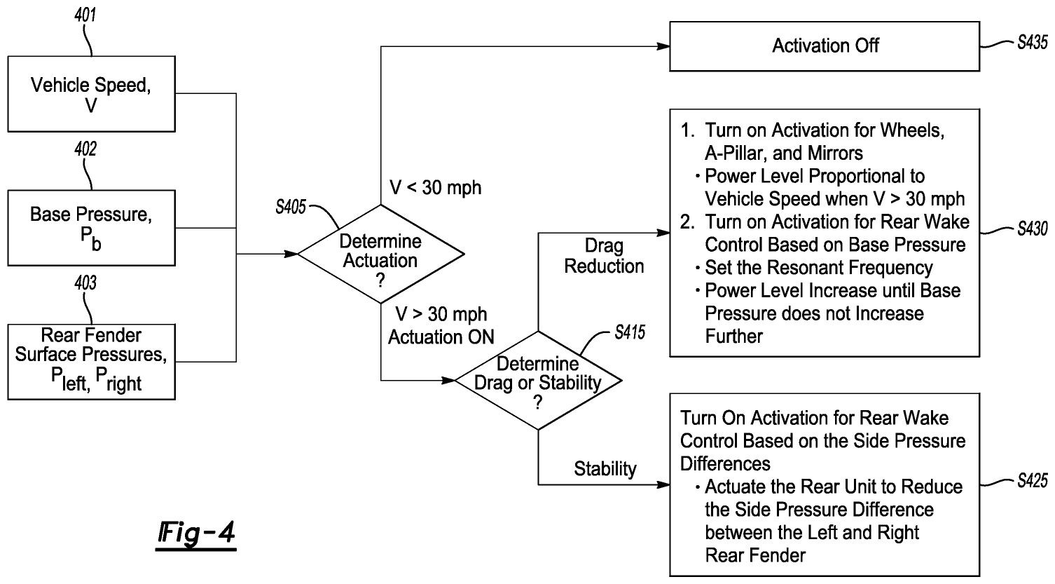

FIG. 4 shows a flow diagram of the apparatus configured to reduce drag according to an aspect of an exemplary embodiment. Referring to FIG. 4, one or more from among a vehicle speed information 401, base pressure information 402, and rear left and rear right fender surface pressure information 403 are provided by respective sensors 105.

In operation S405, it is determined whether the apparatus configured to reduce drag is to be actuated based on the values of the vehicle speed information 401, base pressure information 402, and rear left and rear right fender surface pressure information 403. For example, if vehicle speed information 401 indicates that the vehicle speed is less than a predetermined actuation speed (e.g., 30 mph), the apparatus configured to reduce drag may be turned off in operation S435.

However, if the vehicle speed is greater than a predetermined actuation speed, it may be determined whether to actuate drag reduction or stability control in operation S415. If stability control is actuated either by manual input or if there is a difference in the rear left and rear right fender surface pressure as determined from rear left and rear right fender surface pressure information 403 and/or the difference in the rear left and rear right fender surface pressure is greater than predetermined pressure difference, stability control or rear wake control may be achieved by actuating the piezoelectric bellows on the lower pressure side of the vehicle to increase surface pressure to stabilize the vehicle in operation S425.

If drag control is actuated, the piezoelectric bellows in one or more areas of the vehicle may be actuated and the power level of the piezoelectric bellows may be set to a power level proportional to the vehicle speed if the vehicle speed is greater than a predetermined actuation speed in operation S430. In addition, rear wake control may be achieved by setting the resonant frequency of the piezoelectric bellows according to the base pressure information and increasing the power level until the base pressure stops increasing in operation S430.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. An apparatus configured to reduce drag, the apparatus comprising:
a piezoelectric bellow configured to generate airflow;
a power controller configured to output a signal to actuate the piezoelectric bellow; and
a controller configured to control the power controller based on at least one from among pressure information and vehicle speed.

2. The apparatus of claim 1, wherein the piezoelectric bellow is disposed on one or more from among a top of a side view mirror of a vehicle, an A pillar of a vehicle, a bottom of an area under a front bumper of a vehicle, a bottom of an area between front and back wheels of a vehicle, wheel wells of a vehicle, a top of a trunk, a liftgate, a tailgate or a hatch of a vehicle, a bottom of an area under a rear bumper of a vehicle, and a vertical edge at a driver side or passenger side of a rear of a vehicle.

3. The apparatus of claim 3, wherein the piezoelectric bellow comprises a plurality of piezoelectric bellows.

4. The apparatus of claim 1, wherein the piezoelectric bellow comprises a top member, a bottom member and an inner member disposed in between the top and bottom members,
wherein the inner member comprises a cavity and a nozzle, and
wherein the top and bottom members comprise a piezoelectric disc and a flexible diaphragm disposed around a circumferential axis of the piezoelectric disc.

5. The apparatus of claim 1, wherein the controller configured to control the power controller to actuate the piezoelectric bellow if the vehicle speed is greater than predetermined actuation speed.

6. The apparatus of claim 1, wherein the power controller is configured to adjust the power in range between 50 V and 200 V according to the speed of the vehicle and the pressure information.

7. The apparatus of claim 6, further comprising a vehicle speed sensor configured to measure a speed of a vehicle,
wherein the controller is configured to control the power controller to adjust a frequency and a voltage of power supplied to the piezoelectric bellow according to the speed of the vehicle measured by the speed sensor.

8. The apparatus of claim 7, further comprising a pressure sensor configured to measure a pressure of an area behind a vehicle or at a rear fender of a vehicle,
wherein the controller is configured to control the power controller to adjust the frequency and the voltage of power supplied to the piezoelectric bellow according to the speed of the vehicle and the pressure measured by the pressure sensor.

9. The apparatus of claim 8, wherein the power controller is configured to adjust the frequency in range between 100 Hz and 800 Hz according to the speed of the vehicle and the base pressure.

10. The apparatus of claim 6, further comprising a pressure sensor configured to measure a pressure of an area behind a vehicle or at a rear fender of a vehicle,
wherein the controller is configured to control the power controller to adjust the frequency and the voltage of power supplied to the piezoelectric bellow according to the speed of the vehicle and the pressure measured by the pressure sensor.

11. The apparatus of claim 1, wherein the piezoelectric bellow is disposed on one or more from among a top of a side view mirror of a vehicle, an A pillar of a vehicle and a bottom of an area under a front bumper of a vehicle.

12. The apparatus of claim 1, wherein the piezoelectric bellow is disposed on one or more from among a top of a trunk, a liftgate, a tailgate or a hatch of a vehicle, a bottom of an area under a rear bumper of a vehicle, and a vertical edge at a driver side or passenger side of a rear of a vehicle.

13. The apparatus of claim 1, wherein the piezoelectric bellow is disposed on one or more from among a bottom of an area between front and back wheels of a vehicle and wheel wells of a vehicle.

14. The apparatus of claim 1, wherein the piezoelectric bellow comprises a top member, a bottom member and an inner member disposed in between the top and bottom members,
wherein the inner member comprises a cavity and a nozzle, and
wherein the top member comprises a piezoelectric disc and a flexible diaphragm disposed around a circumferential axis of the piezoelectric disc.

15. The apparatus of claim 1, further comprising a pressure sensor configured to measure a pressure of an area around the vehicle and provide the measured pressure to the controller.

16. The apparatus of claim 1, further comprising a vehicle speed sensor configured to measure a speed of a vehicle and provide the measured speed to the controller.

17. An apparatus configured to reduce drag, the apparatus comprising:
a vehicle speed sensor configured to provide information on vehicle speed;
a pressure sensor configured to provide pressure information on an exterior area of a vehicle;
a plurality of piezoelectric bellows disposed on an exterior of a vehicle and configured to generate airflow; and
a controller configured to actuate the plurality of piezoelectric bellows based on at least one from among the pressure information and the vehicle speed.

18. The apparatus of claim 17, wherein the piezoelectric bellows are disposed on one or more from among a top of a side view mirror of a vehicle, A pillar of a vehicle, a bottom of an area under a front bumper of a vehicle, a bottom of an area between front and back wheels of a vehicle, wheel wells of a vehicle, a top of a trunk, a liftgate, a tailgate or a hatch of a vehicle, a bottom of an area under a rear bumper of a vehicle, and a vertical edge at a driver side or passenger side of a rear of a vehicle.

19. The apparatus of claim 17, wherein the controller is configured to control to actuate the piezoelectric bellows according to the speed of the vehicle measured by the speed sensor.

20. The apparatus of claim 17, wherein the controller is configured to control to actuate the piezoelectric bellows according to the speed of the vehicle and the pressure measured by the pressure sensor.
